(19) United States
(12) Patent Application Publication
(10) Pub. No.: US 2026/0124084 A1
(43) Pub. Date: May 7, 2026

(54) ADJUSTING CHAIR

(71) Applicant: MERITS HEALTH PRODUCTS CO., LTD., Taichung City (TW)

(72) Inventors: Ming-Chuan CHENG, Taichung City (TW); Shun-Yuan CHENG, Taichung City (TW)

(21) Appl. No.: 19/204,609

(22) Filed: May 12, 2025

(30) Foreign Application Priority Data
Nov. 6, 2024 (TW) 113142489

(51) Int. Cl. A61G 5/10

(52) U.S. Cl. CPC A61G 5/1067

(57) ABSTRACT

An adjusting chair includes a seat frame, a backrest frame, a backrest sliding mechanism, a backrest linkage mechanism and a driving mechanism. The backrest frame is pivotally disposed at the seat frame and includes a first rail having a first guiding direction, and a second rail spaced apart from the first rail and has a second guiding direction. The backrest sliding mechanism includes a sliding element movably disposed at the first rail, and a backrest assembly connected to the sliding element. The backrest linkage mechanism is connected to the backrest sliding mechanism and guided by the second rail. The driving mechanism drives the backrest frame to rotate relative to the seat frame, the backrest linkage mechanism is moved along the second rail to drive the sliding element to move in the first rail, and the backrest assembly is moved relative to the backrest frame.

### RELATED APPLICATIONS

This application claims priority to Taiwan Application Serial Number 113142489, filed Nov. 6, 2024, which is herein incorporated by reference.

### BACKGROUND

### Technical Field

The present disclosure relates to an adjusting chair. More particularly, the present disclosure relates to an adjusting chair with a tiltable backrest.

### Description of Related Art

Chairs generally include a seat frame and a backrest, and the backrest may be configured for a back of a human body to rest thereon. In order to increase using comfort, the chair usually has a backrest adjusting function, which can allow the backrest to be pivoted relative to the seat frame, and the back of the human body may be relative inclined.

Generally, as the user would like to adjust the backrest, the upper body may be straightened and then the backrest is adjusted, but for some elders or users who cannot control their bodies, the upper body may contacts with the backrest, and the back may be pulled when adjusting the angles, thereby generating discomfort.

Based on the above, how to modify the structure of the chair to increase the using comfort becomes a target that those in the field pursue.

### SUMMARY

According to one aspect of the present disclosure, an adjusting chair includes a seat frame, a backrest frame, a backrest sliding mechanism, a backrest linkage mechanism and a driving mechanism. The backrest frame is pivotally disposed at the seat frame and includes a first rail and a second rail. The first rail has a first guiding direction parallel to a length direction of the backrest frame. The second rail is spaced apart from the first rail and has a second guiding direction, and the second guiding direction is parallel to the length direction. The backrest sliding mechanism includes a sliding element and a backrest assembly. The sliding element is movably disposed at the first rail. The backrest assembly is connected to the sliding element. The backrest linkage mechanism is connected to the backrest sliding mechanism and guided by the second rail. The driving mechanism is connected to the backrest frame. The driving mechanism drives the backrest frame to rotate relative to the seat frame, the backrest linkage mechanism is moved along the second rail to drive the sliding element to move in the first rail, and the backrest assembly is moved relative to the backrest frame.

According to one aspect of the present disclosure, an adjusting chair includes a seat frame, a backrest frame, a backrest sliding mechanism, a backrest linkage mechanism and a driving mechanism. The backrest frame is pivotally disposed at the seat frame and includes a first rail, the first rail has a first guiding direction parallel to a length direction of the backrest frame, and the first rail includes a rail frame and an inner pad. The inner pad is disposed within the rail frame and forms a guiding space. The backrest sliding mechanism includes a sliding element and a backrest assembly, the sliding element is movably accommodated in the guiding space, and the sliding element has a rod structure for coordinating with the guiding space. The backrest assembly is connected to the sliding element. The backrest linkage mechanism is connected to the backrest sliding mechanism. The driving mechanism is connected to the backrest frame. The driving mechanism drives the backrest frame to rotate relative to the seat frame, the backrest linkage mechanism drives the sliding element to move in the first rail, and the backrest assembly is moved relative to the backrest frame.

### BRIEF DESCRIPTION OF THE DRAWINGS

The present disclosure can be more fully understood by reading the following detailed description of the embodiment, with reference made to the accompanying drawings as follows:

FIG. 1 shows a three-dimension schematic view of an adjusting chair according to one embodiment of the present disclosure.

FIG. 2 shows a partial exploded view of the adjusting chair of the embodiment of FIG. 1.

FIG. 3 shows a partial enlarged view of the adjusting chair of the embodiment of FIG. 1.

FIG. 4 is a partial cross-sectional view of the adjusting chair of the embodiment of FIG. 1 taken along line 4-4.

FIG. 5 shows one front view of a sliding element, a backrest sliding mechanism and a backrest frame of the adjusting chair of the embodiment of FIG. 1.

FIG. 6 shows another front view of the sliding element, the backrest sliding mechanism and the backrest frame of the adjusting chair of the embodiment of FIG. 1.

### DETAILED DESCRIPTION

It will be understood that when an element (or mechanism or module) is referred to as being “disposed on”, “connected to” or “coupled to” another element, it can be directly disposed on, connected or coupled to the other element, or intervening elements may also be present. In contrast, when an element is referred to as being “directly disposed on”, “directly connected to” or “directly coupled to” another element, there are no intervening elements present.

In addition, the terms first, second, third, etc. are used herein to describe various elements or components, these elements or components should not be limited by these terms. Consequently, a first element or component discussed below could be termed a second element or component.

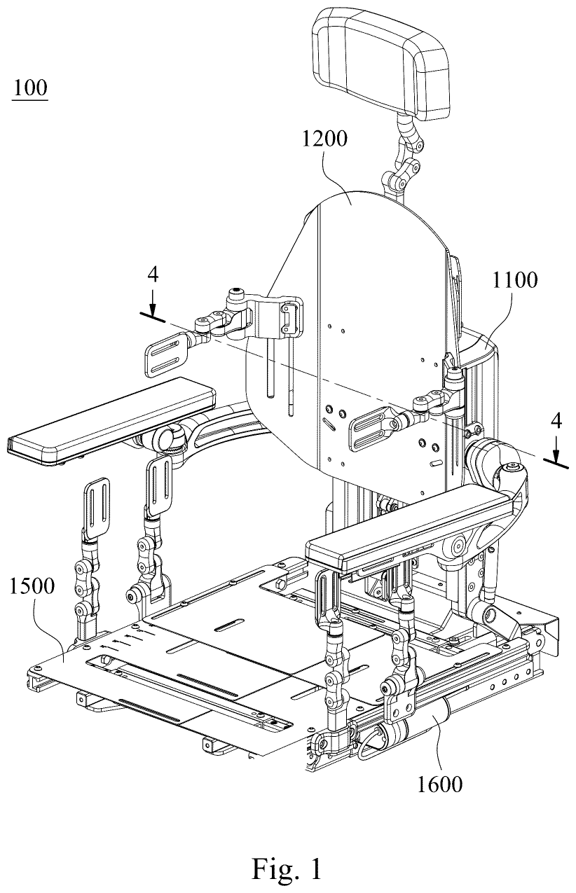

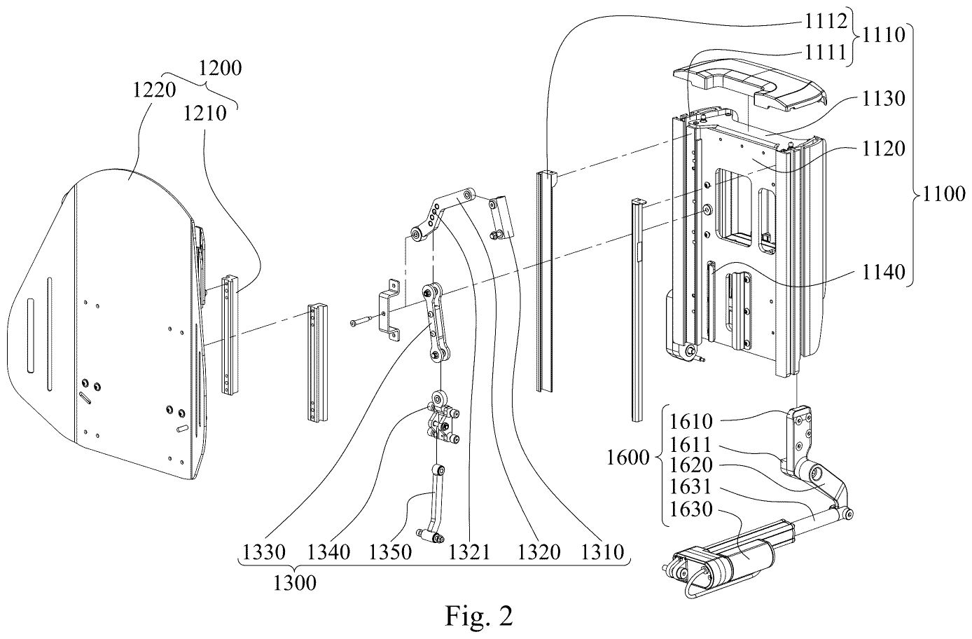

Please refer to FIG. 1 and FIG. 2, FIG. 1 shows a three-dimension schematic view of an adjusting chair 100 according to one embodiment of the present disclosure, and FIG. 2 shows a partial exploded view of the adjusting chair 100 of the embodiment of FIG. 1. The adjusting chair 100 includes a seat frame 1500, a backrest frame 1100, a backrest sliding mechanism 1200, a backrest linkage mechanism 1300 and a driving mechanism 1600. The backrest frame 1100 is pivotally disposed at the seat frame 1500 and includes a first rail 1110. The first rail 1110 has a first guiding direction parallel to a length direction of the backrest frame 1100. The backrest sliding mechanism 1200 includes a sliding element 1210 and a backrest assembly 1220. The sliding element 1210 is movably disposed at the first rail 1110. The backrest assembly 1220 is connected to the sliding element 1210. The backrest linkage mechanism 1300 is connected to the backrest assembly 1220. The driving mechanism 1600 is connected to the backrest frame 1100. The driving mechanism 1600 drives the backrest frame 1100 to rotate relative to the seat frame 1500, the backrest linkage mechanism 1300 drives the sliding element 1210 to move in the first rail 1110, and the backrest assembly 1220 is moved relative to the backrest frame 1100.

Therefore, with the configuration of the backrest frame 1100, the backrest sliding mechanism 1200, the backrest linkage mechanism 1300 and the driving mechanism 1600, the backrest assembly 1220 may slide relative to the backrest frame 1100 as the backrest frame 1100 is pivoted, the user is not affected, and the using comfort is increased.

The adjusting chair 100 in the present disclosure may have a wheel chair structure, and thus may further include a base and at least three wheels. The seat frame 1500 may be disposed at the base, a number of the wheels may be four and the wheels are disposed at the base. In order to clarify the drawings, the base and the wheels are omitted in the present disclosure, and the present disclosure is not limited by the drawings. In other embodiments, the adjusting chair may be a common chair and includes lags, and is not limited thereto.

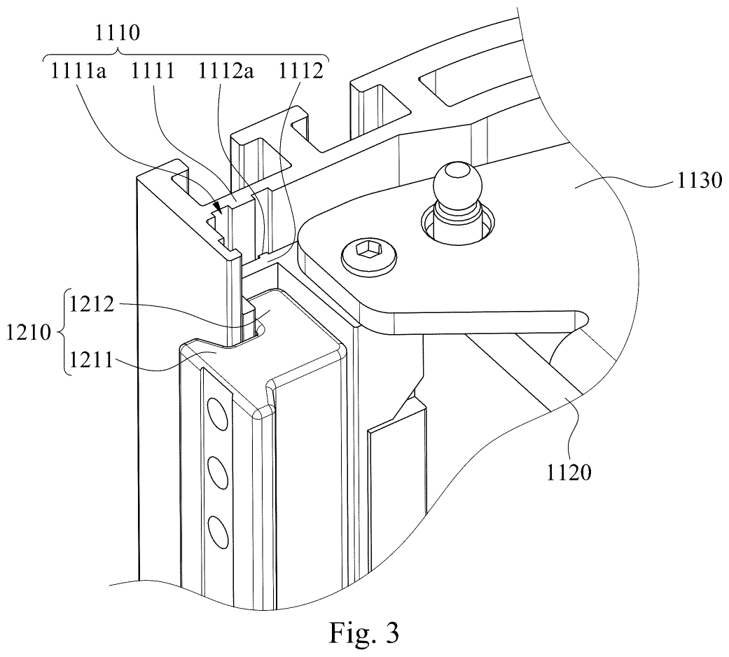

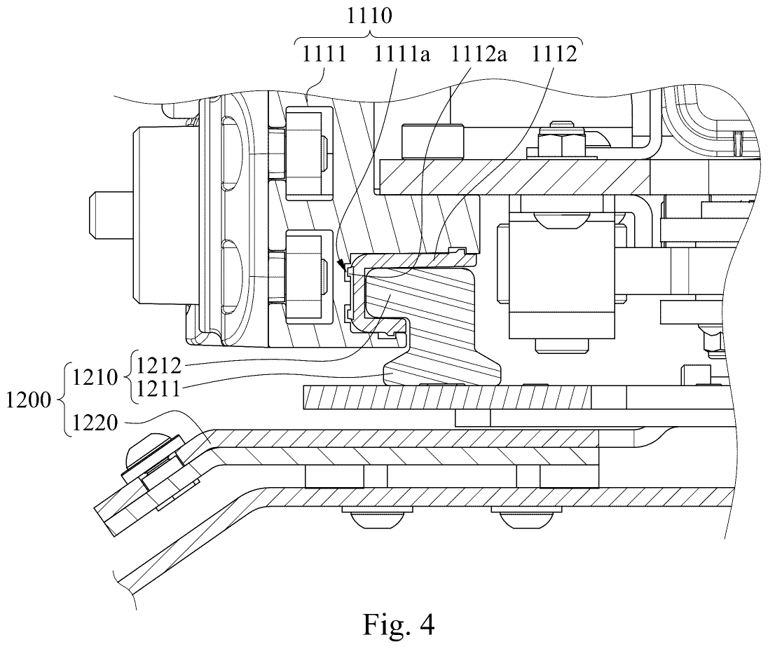

Please refer to FIG. 3 and FIG. 4, with reference of FIG. 2, FIG. 3 shows a partial enlarged view of the adjusting chair 100 of the embodiment of FIG. 1, and FIG. 4 is a partial cross-sectional view of the adjusting chair 100 of the embodiment of FIG. 1 taken along line 4-4. In the embodiment of FIG. 1 to FIG. 4, a number of the first rails 1110 are two, the two first rail 1110 are arranged symmetrically, each of the first rails 1110 includes a rail frame 1111 and an inner pad 1112, the inner pad 1112 is disposed within the rail frame 1111 and forms a guiding space, the rail frame 1111 may have a metal body, and the inner pad 1112 may have a groove-shaped plastic body.

Precisely, the backrest frame 1100 may further include a disposing board 1120 and a mounting board 1130, the mounting board 1130 is configured for the backrest linkage mechanism 1300 to be disposed thereon, the mounting board 1130 is located above the disposing board 1120, and the two rail frames 1111 are respectively located at two sides of the disposing board 1120. Each of the rail frames 1111 is divided into a front segment and a rear segment by the disposing board 1120. A first side of each of the front segments facing toward the disposing board 1120 forms a groove for accommodating each of the inner pads 1112 therein. A second side of the each of the front segments facing away from the disposing board 1120 may form a fastening groove. An installation space may be formed by the two rear segments and the disposing board 1120, and other elements may be installed in the installation space.

The rail frame 1111 is made of a metal material and has the metal body, the inner pad 1112 may be fastened to the mounting board 1130, and the inner pad 1112 is made of a plastic material and thus has the groove-shaped plastic body for being disposed in the groove, thereby being coordinated with the rail frame 1111, and generating wear-resistance and self-lubrication effect with the configuration of dissimilar materials. The rail frame 1111 may further include at least one positioning groove 1111a, the inner pad includes at least one rib 1112a, and the at least one rib 1112a protrudes into the at least one positioning groove 1111a. As shown in FIG. 3, a number of the positioning grooves 1111a is three, each of the positioning grooves 1111a extends along the length direction, and a number of the ribs 1112a corresponds to the number of the positioning grooves 1111a and is also three, so that the inner pad 1112 and the rail frame 1111 may be firmly combined. It is noted that, the rail frame of the present disclosure indicates a structure forming a groove for accommodating the inner pad, a rail frame may be made independently and combine other elements by other fixing methods, or include other extending portions for serving as the side boards or the front board, and the present disclosure is not limited thereto.

The backrest frame 1100 may include two second rails 1140, the second rails 1140 are disposed at the disposing board 1120 and arranged symmetrically, each of the second rails 1140 may be located at a lower portion of the disposing board 1120, each of the second rails 1140 may include a guiding groove, the two guiding grooves face each other, and the second rails 1140 may be used to restrict the first sliding rod 1330.

A number of the sliding elements 1210 of the backrest sliding mechanism 1200 is two, each of the sliding elements 1210 is movably received in the guiding space of each of the inner pads 1112, and each of the sliding elements 1210 may have a rod structure for being coordinated with the guiding space, thereby sliding stably and reducing the noise. Precisely, as shown in FIG. 2 and FIG. 3, each of the sliding elements 1210 include a fastening portion 1211 and a sliding portion 1212, the fastening portion 1211 and the sliding portion 1212 are connected to form an “L” shape, the sliding portion 1212 protrudes into the guiding space, and the fastening portion 1211 may be fastened to the backrest assembly 1220. The backrest assembly 1220 may be configured for the user to lie thereon, thereby supporting the back of the user.

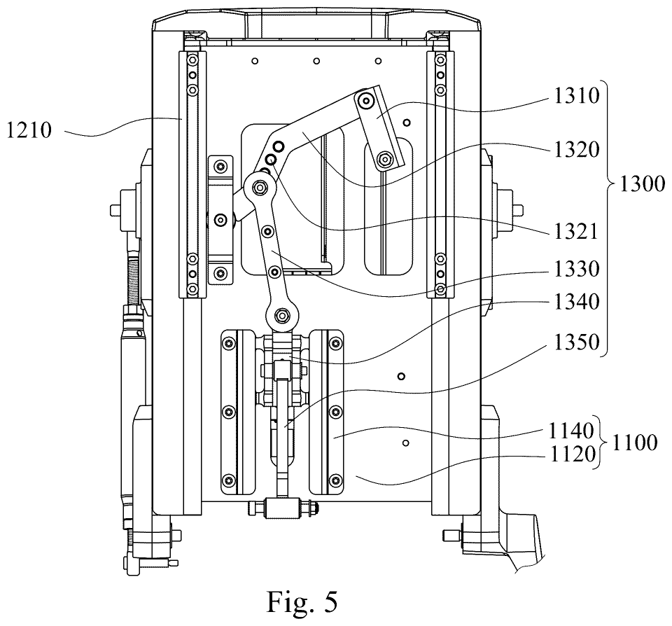

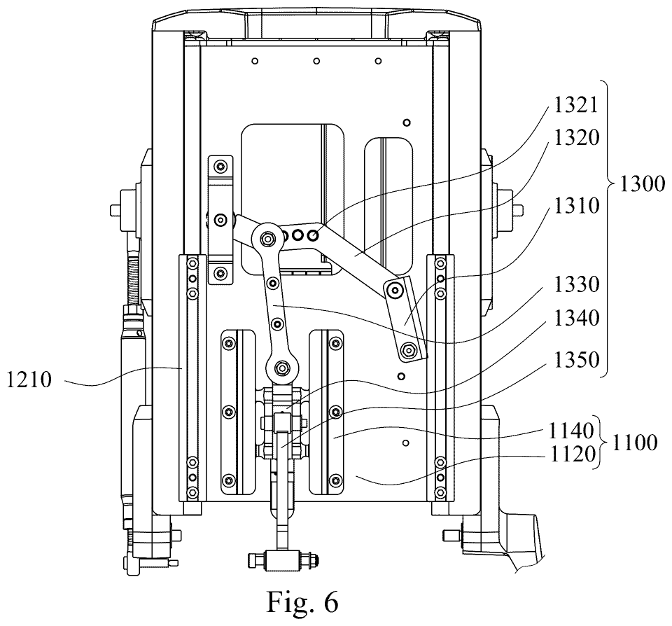

Please refer to FIG. 5 and FIG. 6, with reference of FIG. 2, FIG. 5 shows one front view of the sliding element 1210, the backrest sliding mechanism 1200 and the backrest frame 1100 of the adjusting chair 100 of the embodiment of FIG. 1, and FIG. 6 shows another front view of the sliding element 1210, the backrest sliding mechanism 1200 and the backrest frame 1100 of the adjusting chair 100 of the embodiment of FIG. 1. As shown in FIG. 2, FIG. 5 and FIG. 6, the backrest linkage mechanism 1300 may include a connecting rod 1310, a swinging rod 1320 and a first sliding rod 1330. The connecting rod 1310 is pivotally connected to the backrest assembly 1220. One end of the swinging rod 1320 is pivotally connected to the backrest frame 1100 and another end thereof is pivotally connected to the connecting rod 1310, and the swinging rod 1320 includes at least two pivoting holes 1321. An upper end of the first sliding rod 1330 is pivotally connected to any one of the at least two pivoting holes 1321, and a lower end of the first sliding rod 1330 is restricted by the backrest frame 1100.

To be more specific, one end of the swinging rod 1320 located at a left side is pivotally connected to the disposing board 1120, and may pivot relative to the disposing board 1120; one end of the swinging rod 1320 located at a right side may be pivotally connected to one end of the connecting rod 1310 located at an upper side, one end of the connecting rod 1310 located at a lower side may be pivotally connected to a back board of the backrest assembly 1220, and therefore the connecting rod 1310 may pivot relative to the swinging rod 1320 and the back board simultaneously. A number of the at least two pivoting holes 1321 is three, and the pivoting holes 1321 may be arranged between two ends of the swinging rod 1320. The upper end of the first sliding rod 1330 may for example be pivotally connected to the left most pivoting hole 1321, and a lower end of the first sliding rod 1330 may be restricted by the two second rails 1140. As the first sliding rod 1330 moves along the second rail 1140, the swinging rod 1320 may be swung and move the connecting rod 1310, thereby driving the backrest assembly 1220 to slide. The upper end of the first sliding rod 1330 may be pivotally connected to different pivoting hole 1321, and the moving amplitude of the backrest assembly 1220 relative to the backrest frame 1100 may be adjusted. In other embodiments, the swinging rod and the connecting rod may be a one-piece element, one end of the connecting rod may be pivotally connected to the backrest assembly and connected to a sliding block, the backrest frame may further include a third rail located at the disposing board, and the sliding block slides in the third rail.

The backrest linkage mechanism 1300 may further include a slider 1340 and a second sliding rod 1350. The slider 1340 is slidably disposed at the second rail 1140 and is pivotally connected to first sliding rod 1330. One end of the second sliding rod 1350 is pivotally connected to the slider 1340 and another end thereof is pivotally connected to the seat frame 1500. The slider 1340 may further include a bracket body (not labeled) and four rollers (not labeled), two of the rollers are located at one side of the bracket body and received in one of the second rail 1140, and another two of the rollers are located at another side of the bracket body and received in another one of the second rail 1140. As the slider 1340 is moved in the second rails 1140, the first sliding rod 1330 is moved. In other embodiments, the backrest linkage mechanism can be composed of any linkage rods, the backrest frame may include rails coordinate with the linkage rods, or the rails may not be included, but the present disclosure is not limited thereto.

As shown in FIG. 2, the driving mechanism 1600 may include a fixing board 1610, a pushing rod 1620 and an actuator 1630. One end of the fixing board 1610 is connected to the backrest frame 1100. The pushing rod 1620 is connected to another end of the fixing board 1610. The actuator 1630 is connected to and drives the pushing rod 1620. Specially, the actuator 1630 may be an electric cylinder, which includes a telescopic rod 1631. The fixing board 1610 may include a pivoting portion 1611, as the upper end of the mounting board 1610 is fastened to the fastening groove of the rail frame 1111, which faces outward, the lower end may protrude from the rail frame 1111, the pivoting portion 1611 may protrude from the inner side of the lower end to be pivotally connected to the seat frame 1500, one end of the pushing rod 1620, which is located on the upper side, may be fastened to an outer side of the lower end, and one end of the pushing rod 1620, which is located on the lower side, may be pivotally connected to the telescopic rod 1631.

Hence, as shown in FIG. 5 and FIG. 6, as the telescopic rod 1631 of the actuator 1630 shrinks back, the pushing rod 1620 and the fixing board 1610 may pivot relative to the backrest frame 1100. Since the second sliding rod 1350 is pivotally connected to the seat frame 1500, the slider 1340 may be moved in the second rails 1140 owing to the restriction of the second sliding rod 1350, the first sliding rod 1330 moves downward, the swinging rod 1320 rotates about the left side terminal, driving the connecting rod 1310 to move the backrest assembly, 1220, and the sliding element 1210 may slide in the first rail 1110.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An adjusting chair, comprising:
a seat frame;
a backrest frame pivotally disposed at the seat frame and comprising:
a first rail having a first guiding direction parallel to a length direction of the backrest frame; and
a second rail spaced apart from the first rail and having a second guiding direction, wherein the second guiding direction is parallel to the length direction;
a backrest sliding mechanism, comprising:
a sliding element movably disposed at the first rail; and
a backrest assembly connected to the sliding element;
a backrest linkage mechanism connected to the backrest sliding mechanism and guided by the second rail; and
a driving mechanism connected to the backrest frame;
wherein the driving mechanism drives the backrest frame to rotate relative to the seat frame, the backrest linkage mechanism is moved along the second rail to drive the sliding element to move in the first rail, and the backrest assembly is moved relative to the backrest frame.

2. The adjusting chair of claim 1, wherein the first rail comprises:
a rail frame; and
an inner pad disposed within the rail frame;
wherein the sliding element has a rod structure for coordinating with the inner pad.

3. The adjusting chair of claim 2, wherein the rail frame further comprises at least one positioning groove, the inner pad comprises at least one rib, and the at least one rib protrudes into the at least one positioning groove.

4. The adjusting chair of claim 3, wherein the rail frame has a metal body, and the inner pad has a groove-shaped plastic body.

5. The adjusting chair of claim 1, wherein the driving mechanism comprising:
a fixing board, wherein one end of the fixing board is connected to the backrest frame;
a pushing rod connected to another end of the fixing board; and
an actuator connected to and driving the pushing rod.

6. The adjusting chair of claim 1, wherein the backrest linkage mechanism comprising:
a connecting rod pivotally disposed at the backrest assembly;
a swinging rod, wherein one end of the swinging rod is pivotally connected to the backrest frame and another end thereof is pivotally connected to the connecting rod, and the swinging rod comprises at least two pivoting holes;
a first sliding rod, wherein an upper end of the first sliding rod is pivotally connected to any one of the at least two pivoting holes, and a lower end of the first sliding rod is restricted by the second rail;
a slider slidably disposed at the second rail and being pivotally connected to first sliding rod; and
a second sliding rod, wherein one end of the second sliding rod is pivotally connected to the slider and another end thereof is pivotally connected to the seat frame.

7. An adjusting chair, comprising:
a seat frame;
a backrest frame pivotally disposed at the seat frame and comprising a first rail, the first rail having a first guiding direction parallel to a length direction of the backrest frame, and the first rail comprising;
a rail frame; and
an inner pad disposed within the rail frame and forming a guiding space;
a backrest sliding mechanism, comprising:
a sliding element movably accommodated in the guiding space, the sliding element having a rod structure for coordinating with the guiding space; and
a backrest assembly connected to the sliding element;
a backrest linkage mechanism connected to the backrest sliding mechanism; and
a driving mechanism connected to the backrest frame;
wherein the driving mechanism drives the backrest frame to rotate relative to the seat frame, the backrest linkage mechanism drives the sliding element to move in the first rail, and the backrest assembly is moved relative to the backrest frame.

8. The adjusting chair of claim 7, wherein the rail frame further comprises at least one positioning groove, the inner pad comprises at least one rib, and the at least one rib protrudes into the at least one positioning groove.

9. The adjusting chair of claim 8, wherein the rail frame has a metal body, and the inner pad has a groove-shaped plastic body.

10. The adjusting chair of claim 7, wherein the driving mechanism comprising:
a fixing board, wherein one end of the fixing board is connected to the backrest frame;
a pushing rod connected to another end of the fixing board; and
an actuator connected to and driving the pushing rod.
